(19) United States
(12) Patent Application Publication
(10) Pub. No.: US 2019/0138920 A1
(43) Pub. Date: May 9, 2019

(54) SELF-ADAPTIVE SYSTEM AND METHOD FOR LARGE SCALE ONLINE MACHINE LEARNING COMPUTATIONS

(71) Applicant: PayPal, Inc., San Jose, CA (US)

(72) Inventors: Shuang Lin, San Jose, CA (US); Christopher Po-Ho Tang, Shanghai (CN); Yuehao Wu, Cupertino, CA (US); Xiang Zhou, San Jose, CA (US)

(73) Assignee: PayPal, Inc.

(21) Appl. No.: 15/803,479

(22) Filed: Nov. 3, 2017

(51) Int. Cl. G06N 5/04; G06N 99/00; G06F 17/30

(52) U.S. Cl. CPC G06N 5/045; G06F 17/30961; G06N 99/005

(57) ABSTRACT

Aspects of the present disclosure involve systems, methods, devices, and the like for generating a self-adaptive system for large scale online machine learning computations. In one embodiment, a system is introduced that can generate and execute an optimization plan for combining nodes based on relationship information. The execution of the optimization plan can occur at both a static and dynamic state to determine how to best execute node combining. In another embodiment, pool isolation is executed base on the processing information associated with each node.

### TECHNICAL FIELD

The present disclosure generally relates to machine learning in communication devices, and more specifically, to decision structures applicable to machine learning for generating a self-adaptive system.

### BACKGROUND

Nowadays with the evolution and proliferation of electronics, information is constantly being collected and processed. In some instances, the data is used to approve or reject a customer request regarding a transaction. However, the information to be processed can become so large that traditional data processing applications may be inadequate for such processing and analyzing. As such, academia and industry have developed numerous techniques for analyzing the data including machine learning, AB testing, and natural language processing. Machine learning in particular, has received a lot of attention due to its ability to learn and recognize patterns using algorithms that can learn from and make predictions from the data. An algorithm that is commonly used for making predictions includes a prediction model that uses decision structures. Decision structures, use tree like graphing (commonly termed decision trees and/or directed graphs) to map observations, decisions, and outcomes (e.g., quality model scores). Decision trees however, transmitted in their native form, may be too large and thus too time consuming in making a decision for the customer. Thus, it would be beneficial to create a self-adaptive system that can be used for large scale online machine learning computations.

### BRIEF DESCRIPTION OF THE FIGURES

FIG. 1 illustrates a decision structure applicable to machine learning for obtaining a quality model score.

FIG. 2A illustrates a block diagram of an exemplary decision structure applicable to machine learning using static optimization.

FIG. 2B illustrates a block diagram of an exemplary decision structure applicable to machine learning using dynamic optimization.

FIG. 3 illustrates a block diagram of another exemplary decision tree structure applicable to machine learning with pool isolation.

FIG. 4 illustrates a block diagram of an exemplary decision tree structure applicable to machine learning with cost based grouping.

FIG. 5 illustrates a flow diagram illustrating operations for generating a self-adaptive system for large scale online machine learning computations.

FIG. 6 illustrates a block diagram of a self-adaptive system for large scale online machine learning computations.

FIG. 7 illustrates an example block diagram of a computer system suitable for implementing one or more devices of the communication systems of FIGS. 1-5.

Embodiments of the present disclosure and their advantages are best understood by referring to the detailed description that follows. It should be appreciated that like reference numerals are used to identify like elements illustrated in one or more of the figures, whereas showings therein are for purposes of illustrating embodiments of the present disclosure and not for purposes of limiting the same.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Aspects of the present disclosure involve systems, methods, devices, and the like for generating a self-adaptive system for large scale online machine learning computations. In one embodiment, a system is introduced that can generate and execute an optimization plan for combining nodes based on relationship information. The execution of the optimization plan can occur at both a static and dynamic state to determine how to best execute node combining. In another embodiment, pool isolation is executed base on the processing information associated with each node. Upon isolating the nodes based on processing type, pending nodes can further be categorized using cost based grouping. Cost based grouping can be used to combine pending nodes using information such as CPU run time.

Machine learning is a technique that has gain popularity in the big data space for its capacity to process and analyze large amounts of data. In particular, machine learning has grown in popularity due to its ability to learn and recognize patterns found in the data. Various algorithms exist that may be used for learning and predicting in machine learning. The algorithms may include, but are not limited to support vector machines, artificial neural networks, Bayesian networks, decision tree learning, etc. Decision tree learning is one commonly used algorithm that uses decision trees to map observations, decisions, and outcomes. Directed graphs are also common structures used which consist of nodes that are connected to each other in a given direction.

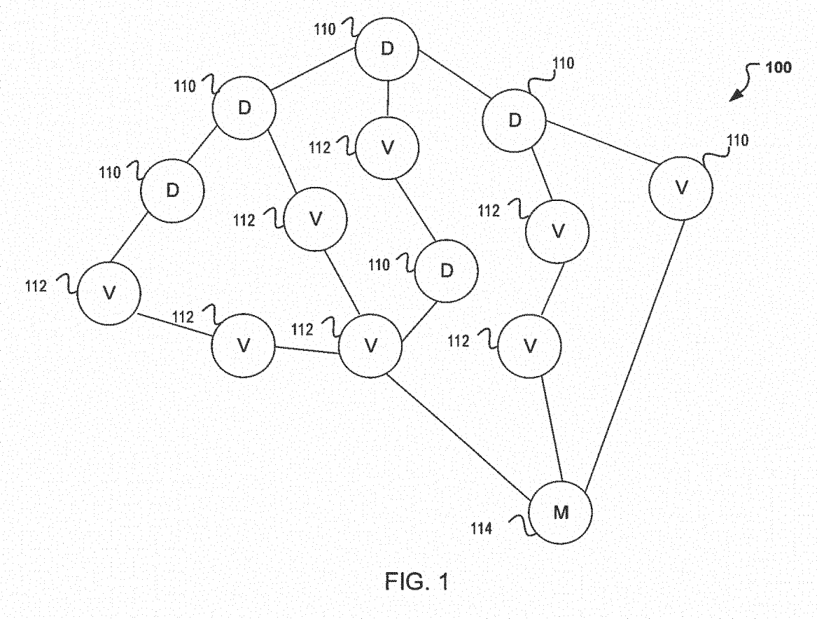

FIG. 1 illustrates a decision structure (e.g., directed graph) applicable to machine learning which may be used for such large data analysis. Generally, a decision structure similar to structure 100 may be used to obtain various metrics. As an example, a decision structure may be used to compute a quality model score which may be used in determining whether or not to approve a customer's transaction request. In particular, the structure 100 illustrated in FIG. 1 may be a directed acyclic graph (DAG). A directed acyclic graph is a type of structure that connects nodes in a given direction, where the nodes are connected in a non-circular fashion. That is to say, a DAG is a rooted tree with no directed cycles, such that on the graph the possibility does not exist to start at a vertex and loop back to the vertex and thus vertices at an edge are directed from an earlier to a later sequence. In FIG. 1, for example, the directed acyclic graph (e.g., structure 100) is a machine learning model capable of receiving a large amount of inputs (e.g., data 110) for customer transactions and compute variables 112 based on the data 110 loading. The variables 112 computed, may then be used as the inputs for obtaining the model outcome 114 (e.g., model quality score) approving or rejecting a customer transaction request or user login for example. Therefore, the inputs can include data gathered from a client, loaded from a database, and the like.

Note that in this exemplary structure, like in a general DAG used, for customer model quality score computation each node can be attached to a thread. Therefore, the number of threads needed, have a linear dependency on the number of nodes on the graph. As an example, to support a computation with 500 nodes, about 100 threads may be need. Similarly, in a system with 10,000 nodes, about 2,000 threads may be necessary. Thus, structure 100 may grow and can extend significantly as the amount of data loading is increased and variable computes needed and determined. As such, FIG. 1 is designed to illustrate the intricacies of a decision structure and how quickly, the structure 100 may become too large and difficult for obtaining metrics such as a quality model score within a given time constraint.

For example, in some instances a service level agreement may exist between two parties to provide a metric and/or decision within a predetermined amount of time. If the time limit is not met, then a decision may automatically be made leading to loss of time, income, and/or customers. To illustrate, consider a service agreement between a customer and a service provider, in which the service provider has a given time constraint (e.g., 80 ms) time frame to determine whether or not a user's transaction request is approved. If the service provider does not provide a decision within the time constraint, the client may automatically approve the transaction and the service provider may be held accountable for the monetary loss. Therefore, it is pertinent to have such a decision model that is slim and efficient such that service level agreement (SLA) are met and losses are mitigated.

In line with the knowledge that DAGs may grow too large for quick processing, a first embodiment is presented which introduces a system and method for quicker large scale online computation. In particular, a self-adaptive system is introduced which may be used for large scale online machine learning computations, such as those used in approving user transaction requests.

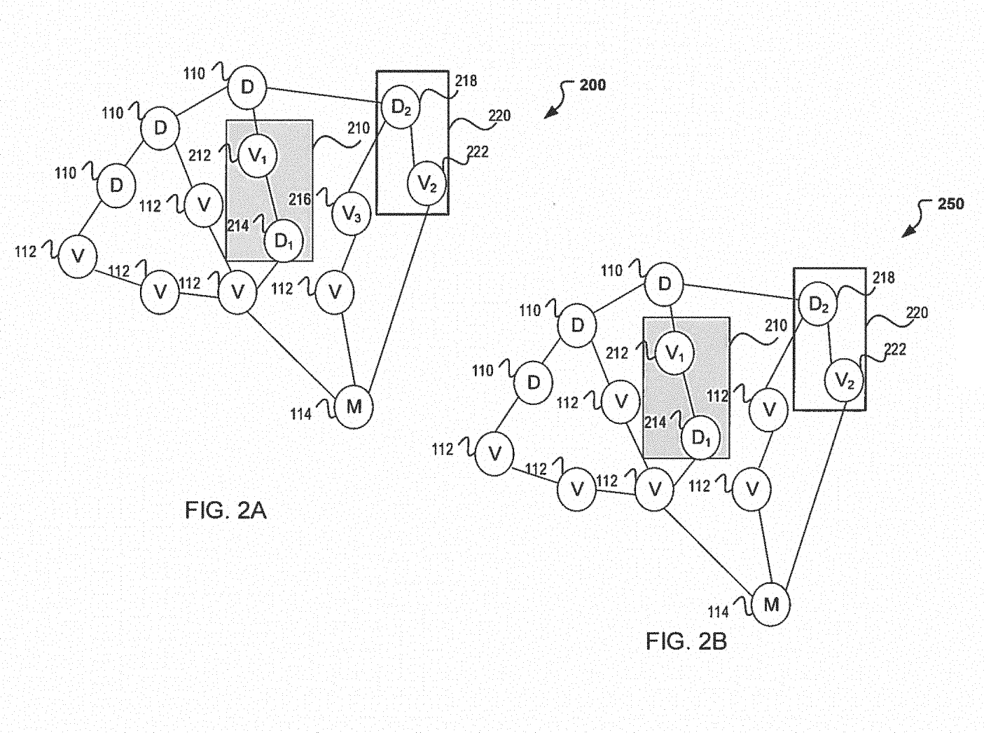

A thread can generally be described as a set of instructions which can be executed by a program to handle multiple concurrent users. As indicated, a linear dependency exists between the number of threads and the number of nodes in the graph. Therefore, if the number of threads needed or alternatively the number of nodes needed, are minimized, then the computation processing time may be minimized as well. FIG. 2A is introduced, which illustrates a first technique which may be implemented in order to achieve a decrease in computation processing time. Particularly, FIG. 2A illustrates a block diagram of an exemplary decision structure 200 applicable to machine learning using static optimization. The concept of static optimization is introduced by analyzing the relationship between the nodes to determine if thread minimization can be achieved through those relationships. In one embodiment, an execution plan may be created by analyzing the static directed acyclic graph (e.g., decision structure 200) and the dependencies between the data 110 and the variables 112. The analysis can include looking at the parent-child relationships found in the decision structure 200 and identifying which of those nodes include this relationship.

For example, in FIG. 2A container 210 illustrates nodes D1 214 and V1 212, which may be combined as there only exists one parent-child relationship. That is to say, the combination of the two nodes to one node, does not change the sequence or any of the dependencies in decision structure 200. On the contrary, if container 220 with nodes D2 218 and V2 222, are combined, because D2 218 and V2 222 do have different dependencies (e.g., V3 216), then the combination of the two nodes (D2 218 and V2 222) may come at a cost with a delay to other nodes and their corresponding start time. Thus, in FIG. 2A, it may not be possible to ensure that container 212 will provide a benefit unless it is considered during run time. Therefore, in FIG. 2A, a first technique is introduced which presents an option to decrease processing time by combining nodes. Additionally and/or alternatively, FIG. 2A is presented as a first step in a multi-step process for reducing the processing time in a DAG model. Note that this first step, can provide the opportunity to optimize the decision structure 200 prior to a production run and provide a plan for possible node combinations at run-time.

Next, in FIG. 2B, a run-time or dynamic optimization technique is illustrated in decision structure 250. This dynamic optimization technique is the execution of the optimization plan determined in FIG. 2B at run-time which can help determine whether other nodes that may have been previously identified may be combined (such as nodes D2 218 and V2 222 of container 220). For example, run time of V2 222 may determine that V2 has a short time. Thus, it is possible to achieve additional processing time savings by combining nodes D2 218 and V2 222 without delays to the system and thus decreasing the number of nodes (and consequently threads) needed to process the model (decision structure 250). Notice that the ability to combine the nodes 218,222 in container 220 reduces and/or eliminates the concern for the dependency of node V3 216 to node D2 218 and container 220 may be executed. Additionally and/or alternatively, additional node pairs may be identified and combined resulting in the number of nodes used. In addition, in some instances, two or more data nodes 110 may be combined with one or more variable nodes 112 if it determined that the sequence and/or dependencies do not change or affect the computation of the model quantity M 114.

Note that additionally or alternatively other node combinations may be possible and the containers 210 and 220 are for exemplary purposes only. In addition, although a data 110 and variable 112 node are illustrated as combined during the execution of the optimization plan, other combinations may be possible with one or more data 110 and variable 112 nodes. Also the execution of node optimization may provide a decrease in the number of nodes used and consequently the number of threads and time used to execute the decision structure 220.

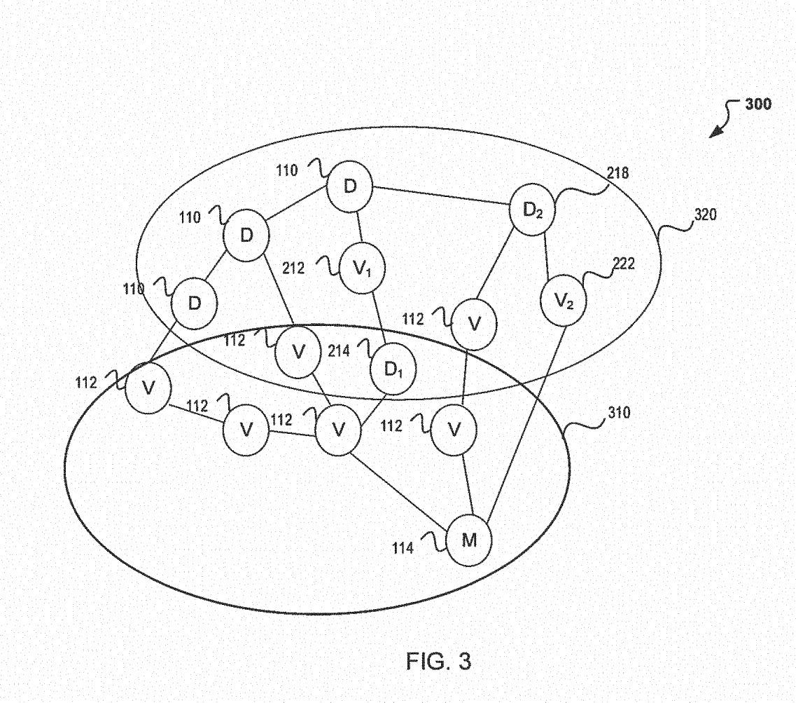

Turning to FIG. 3, a next technique is introduced to enable further decrease in processing time. Again in FIG. 3, the technique continues with the optimized decision structure 300 where further node containment is accomplished. In particular, two ovals 310, 320 are illustrated which encapsulate nodes that share similarities. FIG. 3, for example, illustrates the use of a venn diagram type grouping in which nodes are isolated based on pool type. In one embodiment, the nodes may be classified into an I/O Thread pool 310 and a CPU thread pool 320. A thread pool is can generally include a design pattern for executing a computer program. In a pool thread, multiple threads can wait idle for a task to be assigned or allocated for execution. In a thread pool, a group of threads maybe pre-instantiated such that the idle threads are ready to be given work.

In FIG. 3, the I/O Thread pool 310 can be used to classify those nodes 112,114 which are I/O intensive, while the CPU Thread pool 320 can be used to classify those nodes 110, 112, 212, 218, and 222 which are CPU intensive nodes. By classifying the threads by pool, (e.g., I/O Thread pool 310 and CPU Thread pool 320), processing time may be minimized as those nodes are now eliminated from the pool. For example, in some embodiments, the I/O intensive nodes may not necessitate the use of the CPU Thread pool 320 and as such, the I/O intensive tasks may be submitted to a standalone thread pool. The use of a standalone I/O thread pool 320 is beneficial in that interference with the CPU Thread pool 320 is mitigated (e.g., I/O intensive tasks do not block CPU intensive tasks) and the CPU run time is minimized. Similarly, the isolation of the nodes into a CPU Thread pool 320 enables the run of those nodes which are CPU intensive and thus run (processing) time is mitigated by reducing and/or eliminating those nodes that are I/O intensive.

Therefore, FIG. 3 illustrates that further processing time may be accomplished through the use of venn diagram like techniques where the nodes are classified or isolated by thread pools. The isolation providing a decrease in processing time as those nodes now classified to another thread pool are not blocking the tasks available and idle at the thread pool.

In some instances, the nodes 312, 314 can lie at the intersection of both the CPU Thread pool 320 and the I/O Thread Pool 310. In these instances, a classification of one thread pool may occur (e.g., I/O Thread pool 310) with a potential for update to another thread pool. In other words, a node may classified into one thread pool and then at run-time it may be determined that the classification was incorrect or changed. An incorrect classification can lead to runtime that may be further mitigated as the node placed in incorrect pool can be updated and further processing time savings may occur as tasks (e.g., CPU tasks) are no longer being blocked by the node (e.g., I/O node 312, 314).

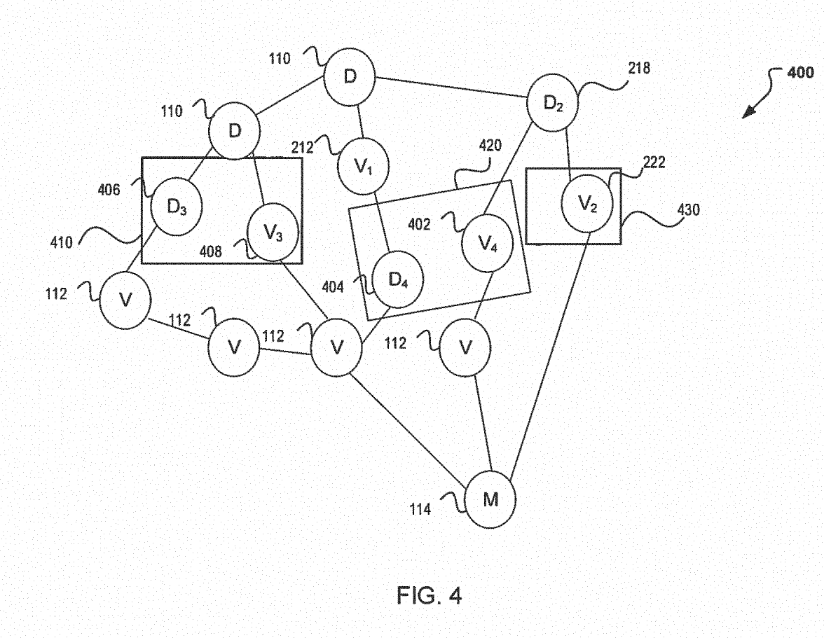

FIG. 4 illustrates yet another technique that can be implemented in conjunction with FIGS. 1-3 in order to provide a self-adaptive system for large scale online machine learning computations. In particular, FIG. 4 illustrates cost based grouping that may be used to reduce the thread needed for running CPU intensive tasks which includes those nodes that may be reclassified. As an example, consider FIG. 4, including decision structure 400, with groupings 410, 420, and 430. The nodes can be grouped into a task group (e.g., groupings 410, 420, 430), where the task groups are allocated according to the thread number of the CPU bound pool. So the tasks may be evenly grouped by the cost.

A task group may be a scheduling unit for the thread pool to handle. The task pool may be used, for example, during run-time such that a one or more nodes (e.g, D3 406 V3 408) are assigned to a task/cost group 410 and the task group 410 is attached to a thread. Therefore, depending on the number of threads available, the nodes available may be grouped accordingly. The grouping may occur in a number of ways including but not limited to, pool type, relationships, CPU time, waiting time, and other cost information collected. As example, FIG. 4 illustrates grouping 410 with nodes D3 406 and V3 408, grouping 420 with nodes D4 404 and V4 402, and grouping 430 with node 422. As such, at runtime, a task group is executed and completed before a new task or task group is picked up and accordingly the tasks groups may start at the same time with completion time at about the same time.

The ability to group such nodes to a common thread can prove advantageous as the number of nodes and threads increases. For example, in instances where the decision structure is as large as 10,000 nodes, groupings can include as many as 100 nodes and a decrease in threads can be achieved from 100 to 1. Such reduction in the number of threads needed presents the opportunity to have a system that is more scalable and with a greater opportunity for completion within the allotted SLA time constraint.

In some embodiments, the techniques presented in FIGS. 2-4 are combined to create a self-adaptive system that is configurable at run-time. CPU time and waiting time may be collected at runtime through sampling and used in training and grouping the nodes accordingly. Additionally, according to runtime data change, the system will reset the configurations to be able to handle the execution pattern as the pattern changes. For example, the traffic received at 5a.m. may be different than that at 3p.m. so the task groupings, node isolation and relationships may need to be updated. In addition, because this system model is available and reconfigurable at run-time, no major changes are necessary and as such is more readily available for making decisions such as quality Risk decisions associated with a user quality model score for the approval or rejection of a product, authorization of a login, etc.

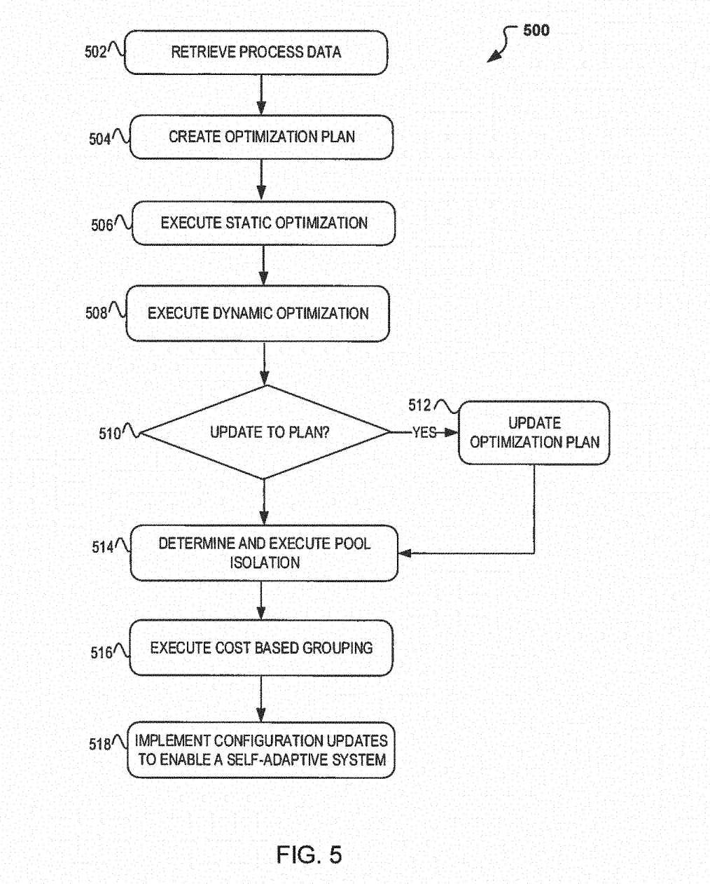

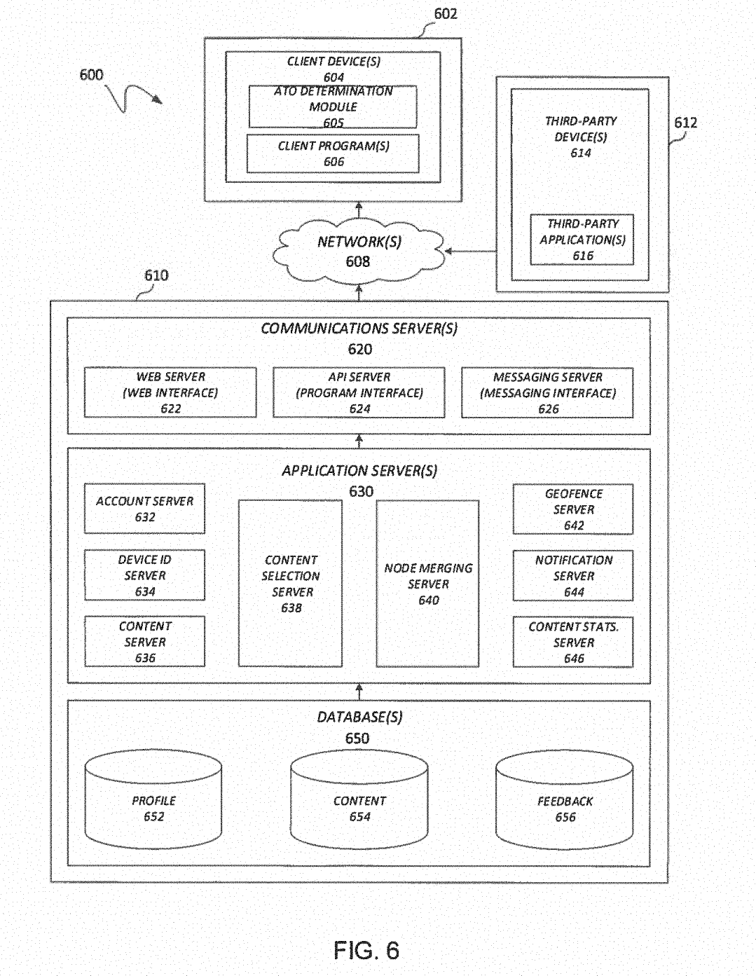

To illustrate how the self-adaptive system may be used, FIG. 5 is introduced which illustrates example process 500 that may be implemented on a system, such as system 600 in FIG. 6. In particular, FIG. 4 illustrates a flow diagram illustrating operations for generating a self-adaptive system for large scale online machine learning computations. According to some embodiments, process 500 may include one or more of operations 502-518, which may be implemented, at least in part, in the form of executable code stored on a non-transitory, tangible, machine readable media that, when run on one or more hardware processors, may cause a system to perform one or more of the operations 502-518.

Process 500 may begin with operation 502, where data is retrieved for analysis. For example, user profile data, transactional information, and other similar data may be retrieved for determining if a transaction is approved. As another example, the data may be retrieved for authenticating a user login.

As previously indicated, large data is constantly collected by devices that oftentimes needs to be organized and analyzed. Machine learning is a technique that is often used for such analytics. Oftentimes, the large data is organized using decision structures or directed acyclic graphs which can be used by the machine learning algorithms to extract the information of interest. In process 500, the data has been organized in a directed acyclic graph format and retrieved for processing and extracting the information of interest.

An obstacle that may be encountered as the data becomes significant and consequently the number of nodes and threads needed, do so as well, is the need for decreased processing time as some of the decisions needed from the DAG may be under SLAs and consequently under time constraints. At operation 504, a first operation is introduced to optimize the number of threads used and in turn reduce the processing time. Operation 504 begins with creating an optimization plan based on relationships between the nodes including those with data and variables. The nodes may be analyzed to determine is a parent-child relationship exists and if other children or dependencies are also part of that relationship. The optimization plan can therefore include determining which nodes can be combined to use a common thread and determining whether if combining the nodes can cause restrictions or delays on other dependent nodes. The optimization plan can be created while the system is in static mode.

To determine whether the optimization plan created has captured all possible combinations, the optimization plan may be executed at operation 506. At operation 506, the system can obtain a better understanding for the node relationships and in some instances identify other possible nodes that may be combined. Such identification may occur at operation 508, where dynamic optimization may occur.

In some embodiments, the dynamic optimization technique of operation 508 can include the execution of the optimization plan determined in operation 504 and executed at run-time to help determine whether other nodes which may have been previously identified may be combined (such as nodes D2 218 and V2 222 of container 220). As indicated, this operation helps identify those nodes which may be combined. In addition, during run time nodes may also be identified which have short processing time such that combining two or more other nodes will not affect processing. Thus, it is possible to achieve additional processing time savings by combining nodes (e.g., D2 218 and V2 222) without delays to the system and thus decreasing the number of nodes (and consequently threads) needed to process the model.

Operation 510 then continues with a determination as to whether the optimization plan requires updating. If it is determined during run-time that other nodes may be combined or some of the combined nodes should not be combined, then process 500 continues to operation 512 where the optimization plan may be updated. Alternatively, if the optimization plan (static or dynamic) does not need any updating, then process 500 may continue to operation 516. At operation 516, a pool isolation approach may be considered and implemented. Pool isolation may include an approach wherein the nodes are combined based on the processing type. For example, I/O intensive nodes may be isolated into an I/O thread pool and CPU intensive nodes are isolated or grouped into CPU thread pools. In this manner any nodes that do not necessitate the CPU, are isolated and moved to another pool (e.g., I/O thread pool) to further minimize processing time.

At operation 516, process 500, implements a task/cost based grouping to manage those nodes that may fall within an intersecting section in a venn like grouping that may occur during pool isolation, at operation 514. In some instances, these nodes may correspond to nodes that may be considered I/O intensive, but at run-time may switch to CPU intensive. At operation 516, to determine how to categorize and/or further decrease the number of threads used for the current DAG, cost based grouping may be occur. That is to say, at operation 516, pending nodes which may remain to ungrouped, isolated, or coupled, are now check for considered for cost best grouping. During cost based grouping, the number of threads available are first considered and then node cost information previously retrieved and/or determined is used. The node information includes cpu time, cost, etc. and used to determine how to best combine two or more nodes such that the nodes are grouped for the number of threads available. For example, if 3 threads and 5 nodes are currently available, then at least two sets of two nodes may be combined for the current threads available.

Once the cost based grouping is executed, process 500 may continue to operation 518 where the system becomes self-adaptive where it may run with the current configurations with the ability to update configurations based on system requirements and traffic flow. Note that other techniques, groupings, and isolation methods may also exist.

FIG. 6 illustrates, in block diagram format, an example embodiment of a computing environment adapted for implementing a system for determining a compact tree representation. As shown, a computing environment 600 may comprise or implement a plurality of servers and/or software components that operate to perform various methodologies in accordance with the described embodiments. Severs may include, for example, stand-alone and enterprise-class servers operating a server operating system (OS) such as a MICROSOFT® OS, a UNIX® OS, a LINUX® OS, or other suitable server-based OS. It may be appreciated that the servers illustrated in FIG. 6 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Computing environment 600 may include, among various devices, servers, databases and other elements, one or more clients 602 that may comprise or employ one or more client devices 604, such as a laptop, a mobile computing device, a tablet, a PC, a wearable device, desktop and/or any other computing device having computing and/or communications capabilities in accordance with the described embodiments. Client devices 604 may include a cellular telephone, smart phone, electronic wearable device (e.g., smart watch, virtual reality headset), or other similar mobile devices that a user may carry on or about his or her person and access readily. Alternatively, client device 604 can include one or more machines processing, authorizing, and performing transactions that may be monitored.

Client devices 604 generally may provide one or more client programs 606, such as system programs and application programs to perform various computing and/or communications operations. Some example system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Some example application programs may include, without limitation, a web browser application, messaging applications (e.g., e-mail, IM, SMS, MMS, telephone, voicemail, VoIP, video messaging, internet relay chat (IRC)), contacts application, calendar application, electronic document application, database application, media application (e.g., music, video, television), location-based services (LBS) applications (e.g., GPS, mapping, directions, positioning systems, geolocation, point-of-interest, locator) that may utilize hardware components such as an antenna, and so forth. One or more of client programs 606 may display various graphical user interfaces (GUIs) to present information to and/or receive information from one or more users of client devices 604. In some embodiments, client programs 606 may include one or more applications configured to conduct some or all of the functionalities and/or processes discussed below.

As shown, client devices 604 may be communicatively coupled via one or more networks 508 to a network-based system 610. Network-based system 610 may be structured, arranged, and/or configured to allow client 602 to establish one or more communications sessions between network-based system 610 and various computing devices 604 and/or client programs 606. Accordingly, a communications session between client devices 604 and network-based system 610 may involve the unidirectional and/or bidirectional exchange of information and may occur over one or more types of networks 608 depending on the mode of communication. While the embodiment of FIG. 6 illustrates a computing environment 600 deployed in a client-server operating relationship, it is to be understood that other suitable operating environments, relationships, and/or architectures may be used in accordance with the described embodiments.

Data communications between client devices 604 and the network-based system 610 may be sent and received over one or more networks 608 such as the Internet, a WAN, a WWAN, a WLAN, a mobile telephone network, a landline telephone network, personal area network, as well as other suitable networks. For example, client devices 604 may communicate with network-based system 610 over the Internet or other suitable WAN by sending and or receiving information via interaction with a web site, e-mail, IM session, and/or video messaging session. Any of a wide variety of suitable communication types between client devices 604 and system 610 may take place, as will be readily appreciated. In particular, wireless communications of any suitable form may take place between client device 604 and system 610, such as that which often occurs in the case of mobile phones or other personal and/or mobile devices.

In various embodiments, computing environment 600 may include, among other elements, a third party 612, which may comprise or employ third-party devices 614 hosting third-party applications 616. In various implementations, third-party devices 614 and/or third-party applications 616 may host applications associated with or employed by a third party 612. For example, third-party devices 614 and/or third-party applications 616 may enable network-based system 610 to provide client 602 and/or system 610 with additional services and/or information, such as merchant information, data communications, payment services, security functions, customer support, and/or other services, some of which will be discussed in greater detail below. Third-party devices 614 and/or third-party applications 616 may also provide system 610 and/or client 602 with other information and/or services, such as email services and/or information, property transfer and/or handling, purchase services and/or information, and/or other online services and/or information and other processes and/or services that may be processes and monitored by system 610.

In one embodiment, third-party devices 614 may include one or more servers, such as a transaction server that manages and archives transactions. In some embodiments, the third-party devices may include a purchase database that can provide information regarding purchases of different items and/or products. In yet another embodiment, third-party severs 614 may include one or more servers for aggregating consumer data, purchase data, and other statistics.

Network-based system 610 may comprise one or more communications servers 620 to provide suitable interfaces that enable communication using various modes of communication and/or via one or more networks 608. Communications servers 620 may include a web server 622, an API server 624, and/or a messaging server 626 to provide interfaces to one or more application servers 630. Application servers 630 of network-based system 610 may be structured, arranged, and/or configured to provide various online services, merchant identification services, merchant information services, purchasing services, monetary transfers, checkout processing, data gathering, data analysis, and other services to users that access network-based system 610. In various embodiments, client devices 604 and/or third-party devices 614 may communicate with application servers 630 of network-based system 610 via one or more of a web interface provided by web server 622, a programmatic interface provided by API server 624, and/or a messaging interface provided by messaging server 626. It may be appreciated that web server 622, API server 624, and messaging server 626 may be structured, arranged, and/or configured to communicate with various types of client devices 604, third-party devices 614, third-party applications 616, and/or client programs 606 and may interoperate with each other in some implementations.

Web server 622 may be arranged to communicate with web clients and/or applications such as a web browser, web browser toolbar, desktop widget, mobile widget, web-based application, web-based interpreter, virtual machine, mobile applications, and so forth. API server 624 may be arranged to communicate with various client programs 606 and/or a third-party application 616 comprising an implementation of API for network-based system 610. Messaging server 626 may be arranged to communicate with various messaging clients and/or applications such as e-mail, IM, SMS, MMS, telephone, VoIP, video messaging, IRC, and so forth, and messaging server 626 may provide a messaging interface to enable access by client 602 and/or third party 612 to the various services and functions provided by application servers 630.

Application servers 630 of network-based system 610 may be a server that provides various services to clients including, but not limited to, data analysis, geofence management, order processing, checkout processing, and/or the like. Application server 630 of network-based system 610 may provide services to a third party merchants such as real time consumer metric visualizations, real time purchase information, and/or the like. Application servers 630 may include an account server 632, device identification server 634, payment server 636, content selection server 638, node merging server 640, geofence server 642, notification server 644, and/or content stats. server 646. These servers, which may be in addition to other servers, may be structured and arranged to configure the system for monitoring queues and identifying ways for reducing queue times.

Application servers 630, in turn, may be coupled to and capable of accessing one or more databases 650 including a profile database 652, a content database 654, feedback database 656, and/or the like. Databases 650 generally may store and maintain various types of information for use by application servers 630 and may comprise or be implemented by various types of computer storage devices (e.g., servers, memory) and/or database structures (e.g., relational, object-oriented, hierarchical, dimensional, network) in accordance with the described embodiments.

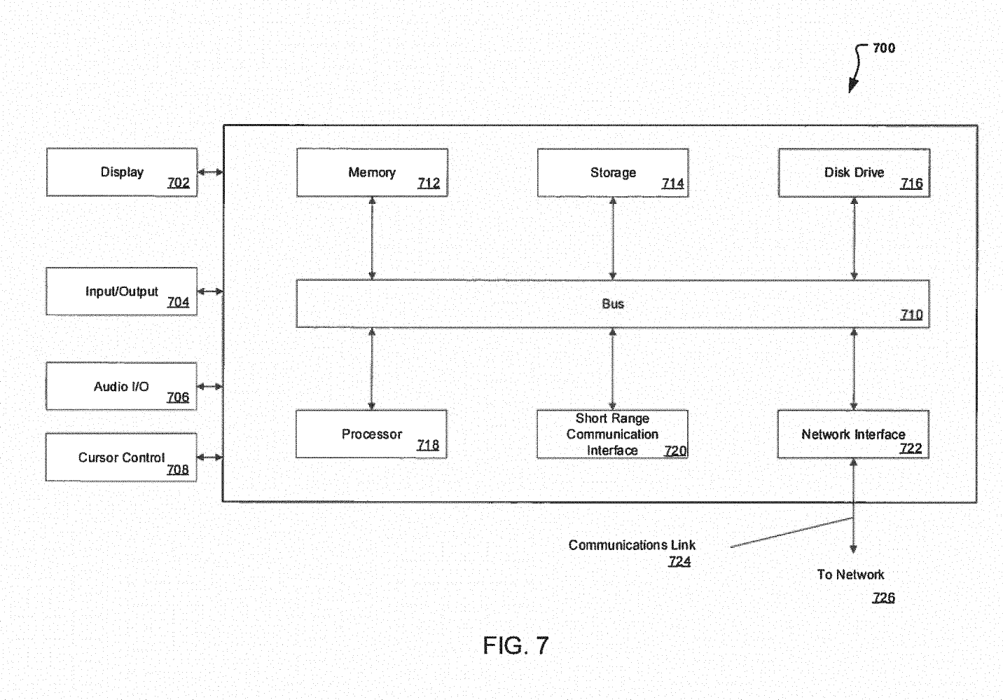

FIG. 7 illustrates an example computer system 700 in block diagram format suitable for implementing on one or more devices of the system in FIGS. 1-6. In various implementations, a device that includes computer system 700 may comprise a personal computing device (e.g., a smart or mobile device, a computing tablet, a personal computer, laptop, wearable device, PDA, etc.) that is capable of communicating with a network 726. A service provider and/or a content provider may utilize a network computing device (e.g., a network server) capable of communicating with the network. It should be appreciated that each of the devices utilized by users, service providers, and content providers may be implemented as computer system 700 in a manner as follows.

Additionally, as more and more devices become communication capable, such as new smart devices using wireless communication to report, track, message, relay information and so forth, these devices may be part of computer system 700. For example, windows, walls, and other objects may double as touch screen devices for users to interact with. Such devices may be incorporated with the systems discussed herein.

Computer system 700 may include a bus 710 or other communication mechanisms for communicating information data, signals, and information between various components of computer system 700. Components include an input/output (I/O) component 704 that processes a user action, such as selecting keys from a keypad/keyboard, selecting one or more buttons, links, actuatable elements, etc., and sending a corresponding signal to bus 710. I/O component 704 may also include an output component, such as a display 702 and a cursor control 708 (such as a keyboard, keypad, mouse, touchscreen, etc.). In some examples, I/O component 704 other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 718, which may be a micro-controller, digital signal processor (DSP), or other processing component, that processes these various signals, such as for display on computer system 700 or transmission to other devices over a network 726 via a communication link 724. Again, communication link 724 may be a wireless communication in some embodiments. Processor 718 may also control transmission of information, such as cookies, IP addresses, images, and/or the like to other devices.

Components of computer system 700 also include a system memory component 714 (e.g., RAM), a static storage component 714 (e.g., ROM), and/or a disk drive 716. Computer system 700 performs specific operations by processor 718 and other components by executing one or more sequences of instructions contained in system memory component 712 (e.g., for engagement level determination). Logic may be encoded in a computer readable medium, which may refer to any medium that participates in providing instructions to processor 718 for execution. Such a medium may take many forms, including but not limited to, non-volatile media, volatile media, and/or transmission media. In various implementations, non-volatile media includes optical or magnetic disks, volatile media includes dynamic memory such as system memory component 712, and transmission media includes coaxial cables, copper wire, and fiber optics, including wires that comprise bus 710. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, hard disk, magnetic tape, any other magnetic medium, CD-ROM, any other optical medium, RAM, PROM, EPROM, FLASH-EPROM, any other memory chip or cartridge, or any other medium from which a computer is adapted to read.

Components of computer system 700 may also include a short range communications interface 720. Short range communications interface 720, in various embodiments, may include transceiver circuitry, an antenna, and/or waveguide. Short range communications interface 720 may use one or more short-range wireless communication technologies, protocols, and/or standards (e.g., WiFi, Bluetooth®, Bluetooth Low Energy (BLE), infrared, NFC, etc.).

Short range communications interface 720, in various embodiments, may be configured to detect other devices with short range communications technology near computer system 700. Short range communications interface 720 may create a communication area for detecting other devices with short range communication capabilities. When other devices with short range communications capabilities are placed in the communication area of short range communications interface 720, short range communications interface 720 may detect the other devices and exchange data with the other devices. Short range communications interface 720 may receive identifier data packets from the other devices when in sufficiently close proximity. The identifier data packets may include one or more identifiers, which may be operating system registry entries, cookies associated with an application, identifiers associated with hardware of the other device, and/or various other appropriate identifiers.

In some embodiments, short range communications interface 720 may identify a local area network using a short range communications protocol, such as WiFi, and join the local area network. In some examples, computer system 700 may discover and/or communicate with other devices that are a part of the local area network using short range communications interface 720. In some embodiments, short range communications interface 720 may further exchange data and information with the other devices that are communicatively coupled with short range communications interface 720.

In various embodiments of the present disclosure, execution of instruction sequences to practice the present disclosure may be performed by computer system 700. In various other embodiments of the present disclosure, a plurality of computer systems 700 coupled by communication link 724 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link 724 and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable media. It is also contemplated that software identified herein may be implemented using one or more computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on the user and user device, however, a customer, a merchant, a service or payment provider may otherwise presented with tailored information. Thus, “user” as used herein can also include charities, individuals, and any other entity or person receiving information. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing instructions; and
a processor configured to execute instructions to cause the system to:
in response to a determination that data is available for processing, retrieve a decision structure of the data;
determine, from the data, nodes on the decision structure, the nodes including user data nodes and variable data nodes;
generate an optimization plan for combining at least two nodes based on the relationship between the nodes;
execute, the optimization plan to determine whether the combining of the at least two nodes is correct;
categorize the optimized nodes on the decision structure into isolation pools based on node processing information; and
execute cost based grouping of optimized nodes that are categorized into two isolation pools.

2. The system of claim 1, wherein the optimization plan includes combining at least a user data node and a variable data node.

3. The system of claim 1, executing instructions further causes the system to:
update, the optimization plan if the combining of the at least two nodes is in error.

4. The system of claim 1, wherein the optimization plan is executed in static and dynamic mode.

5. The system of claim 1, wherein the isolation pools include an I/O thread pool and a CPU thread pool.

6. The system of claim 1, executing instructions further causes the system to:
determine, based on the node processing information, the cost based grouping of the optimized nodes, wherein the node processing information includes CPU time and waiting time, and wherein the nodes with lower CPU times are grouped.

7. The system of claim 1, executing instructions further causes the system to:
update, the optimization plan of the grouped optimized nodes based on new system configuration updates received.

8. A method comprising:
in response to determining that data is available for processing, retrieving a decision structure of the data;
determining, from the data, nodes on the decision structure, the nodes including user data nodes and variable data nodes;
generating an optimization plan for combining at least two nodes based on the relationship between the nodes;
executing, the optimization plan to determine whether the combining of the at least two nodes is correct;
categorizing the optimized nodes on the decision structure into isolation pools based on node processing information; and
executing cost based grouping of optimized nodes that are categorized into two isolation pools.

9. The method of claim 8, wherein the optimization plan includes combining at least a user data node and a variable data node.

10. The method of claim 8, executing instructions further causes the system to:
updating, the optimization plan if the combining of the at least two nodes is in error.

11. The method of claim 8, wherein the optimization plan is executed in static and dynamic mode.

12. The method of claim 8, wherein the isolation pools include an I/O thread pool and a CPU thread pool.

13. The method of claim 8, executing instructions further causes the system to:
determining, based on the node processing information, the cost based grouping of the optimized nodes, wherein the node processing information includes CPU time and waiting time, and wherein the nodes with lower CPU times are grouped.

14. The method of claim 8, executing instructions further causes the system to:
updating, the optimization plan of the grouped optimized nodes based on new system configuration updates received.

15. A non-transitory machine readable medium having stored thereon machine readable instructions executable to cause a machine to perform operations comprising:
in response to determining that data is available for processing, retrieving a decision structure of the data;
determining, from the data, nodes on the decision structure, the nodes including user data nodes and variable data nodes;
generating an optimization plan for combining at least two nodes based on the relationship between the nodes;
executing, the optimization plan to determine whether the combining of the at least two nodes is correct;
categorizing the optimized nodes on the decision structure into isolation pools based on node processing information; and
executing cost based grouping of optimized nodes that are categorized into two isolation pools.

16. The non-transitory medium of claim 15, wherein the optimization plan includes combining at least a user data node and a variable data node.

17. The non-transitory medium of claim 15, executing instructions further causes the system to:
updating, the optimization plan if the combining of the at least two nodes is in error.

18. The non-transitory medium of claim 15, wherein the optimization plan is executed in static and dynamic mode.

19. The non-transitory medium of claim 15, wherein the isolation pools include an I/O thread pool and a CPU thread pool.

20. The non-transitory medium of claim 15, executing instructions further causes the system to:
determining, based on the node processing information, the cost based grouping of the optimized nodes, wherein the node processing information includes CPU time and waiting time, and wherein the nodes with lower CPU times are grouped.
